(19) United States
(12) Patent Application Publication
(10) Pub. No.: US 2012/0001360 A1
(43) Pub. Date: Jan. 5, 2012

(54) CONCRETE BLOCK MOLD WITH DIAMOND INSERT

(75) Inventor: Kevin J. Melvin, Neenah, WI (US)

(73) Assignee: COUNTY MATERIALS CORPORATION, Marathon, WI (US)

(21) Appl. No.: 12/828,968

(22) Filed: Jul. 1, 2010

(51) Int. Cl. B29C 59/02; B29C 33/56

(52) U.S. Cl. 264/119; 249/114.1

(57) ABSTRACT

A block mold for forming a block, comprising a bottom wall, a side wall movable relative to the bottom wall, and a textured material on the side wall (e.g., near a bottom portion of the side wall) and adapted to create a textured surface on the block when the side wall is moved relative to the bottom wall. The textured material comprises abrasive particles (e.g., ten to sixty micron diamond grain) in a matrix (e.g., nickel alloy). In one embodiment, opposing first and second side surfaces of the side wall form two adjacent mold cavities, and the first and second side surfaces each include textured material (e.g., on a lower portion of the respective side surface). Preferably, the side wall includes a side surface defining a plane, and the textured material is applied to the side surface to create the textured surface that protrudes from the plane.

### BACKGROUND

The present invention generally relates to concrete blocks, and specifically to a block mold that creates a rough surface finish on the block

Concrete blocks are typically molded using a mold having sidewalls that are movable relative to a bottom wall of the mold. Liquid concrete is poured into the top of the mold such that it fills the mold cavity formed by the sidewalls and bottom wall. After the concrete is at least partially set, the bottom all can be moved downward relative to the sidewalls so that the block can be removed from the mold. Multiple blocks can be formed simultaneously by using a mold having multiple cavities.

It is often desired to have blocks with a rough texture on at least one side surface of the block. To accomplish this, it is known to form pairs of blocks as a single part with a defined parting line (e.g., with breakaway notches). The parts are then separated by splitting them at the parting line to create a split-face textured surface.

A textured surface can also be formed on a face of a block by providing a lip or other discontinuity on the sidewalls of the mold. For example, the lower edge of the sidewall of the mold can be provided with a rough lip (e.g., a weld bead) such that, when the sidewalls are raised relative to the bottom wall and the block, the rough lip will drag across the face of the block to create a roughened surface.

### SUMMARY

The present invention provides a block mold for forming a block, comprising a bottom wall adapted to form a bottom of the block, a side wall adapted to form a side of the block and movable relative to the bottom wall, and a textured material on the side wall (e.g., near a bottom portion of the side wall) and adapted to create a textured surface on the block when the side wall is moved relative to the bottom wall. The textured material comprises abrasive particles (e.g., ten to sixty micron diamond grain) in a matrix (e.g., nickel alloy). In one embodiment, opposing first and second side surfaces of the side wall form two adjacent mold cavities, and the first and second side surfaces each include textured material (e.g., on a lower portion of the respective side surface).

Preferably, the side wall includes a side surface defining a plane, and the textured material is applied to the side surface to create the textured surface that protrudes from the plane. For example, the textured material can be 0.005 to 0.10 inches thick, and is preferably 0.01 to 0.03 inches thick, and more preferably about 0.02 inches thick.

The present invention also provides a method of forming a block using a block mold having a bottom wall adapted to form a bottom of the block, and a side wall adapted to form a side of the block. The method includes applying (e.g., electroplating, nickel bonding or vacuum brazing) a textured material to the side wall, wherein the textured material includes abrasive particles in a matrix, positioning the bottom wall adjacent to the side wall to form a mold cavity, filling the cavity with a block material, moving the bottom wall and block material relative to the side wall, and scraping the textured material onto a surface of the block material to create a textured surface on the block material.

Other aspects of the invention will become apparent by consideration of the detailed description and accompanying drawings.

### BRIEF DESCRIPTION OF THE DRAWINGS

FIG. 1 is a bottom perspective view of a portion of a block mold embodying the present invention.

FIG. 2 is a side section view taken along line 2-2 in FIG. 1 and showing the block mold empty and in a first position.

FIG. 3 is the side section view of FIG. 2 with the block mold full of block material and in the first position.

FIG. 4 is the side section view of FIG. 2 with the block mold full of block material and moving toward a second position.

FIG. 5 is an enlarged side section view of a lower portion of a side wall of the block mold shown in FIG. 2.

FIG. 6 is an enlarged side section view of a lower portion of a side wall of a block mold according to a second embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, unless specifically noted. Also, the use of the term “block” should not be limited to building materials of a particular shape or size, and should be construed to also cover bricks.

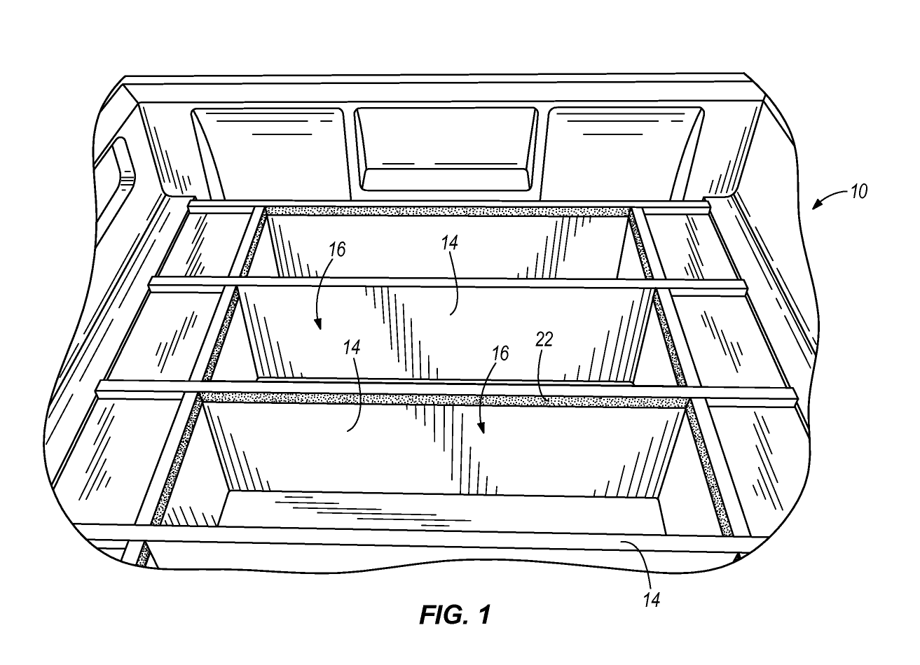

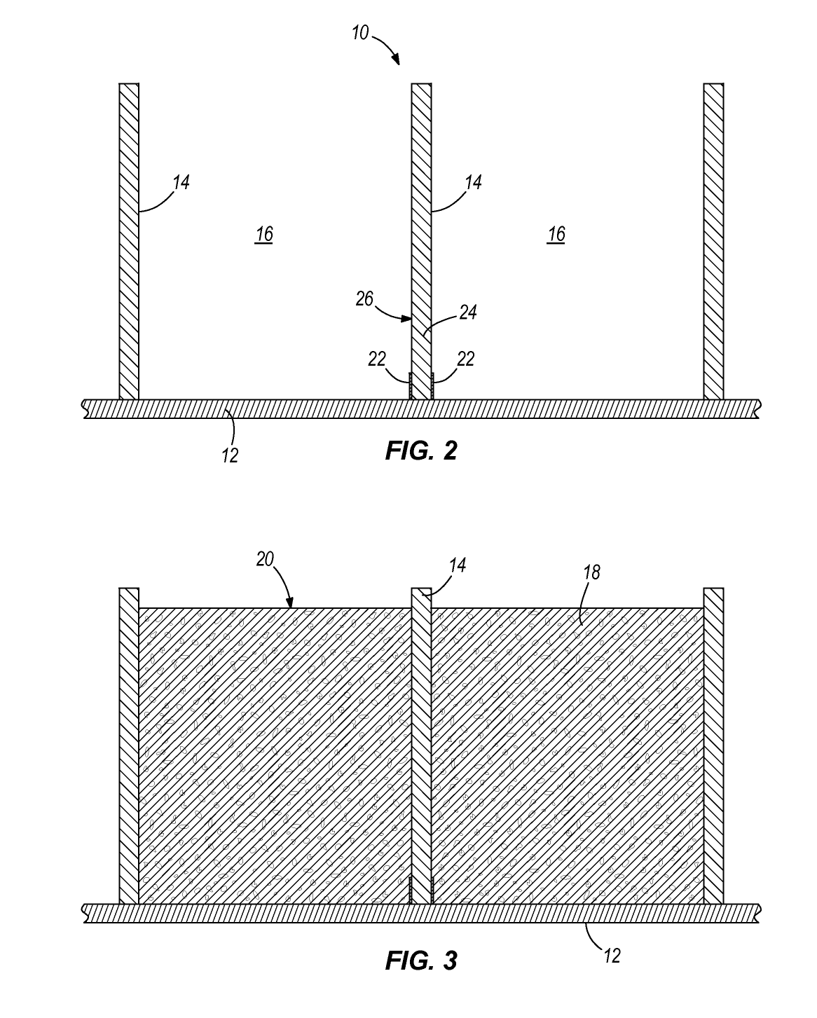

FIG. 1 illustrates a bottom view of a block mold 10. As shown in FIGS. 1 and 2, the block mold 10 has a bottom wall 12 (not shown in FIG. 1) and a series of side walls 14 that cooperate to define multiple mold cavities 16. The illustrated mold cavities 16 are substantially square in cross section, and are adapted to be used to form concrete blocks. If desired, the mold cavities 16 can be in other shapes, and removable cores (not shown) can be used to form openings in the concrete blocks. The illustrated block mold 10 could also be used to form blocks from materials other than concrete.

The block mold 10 is designed such that each cavity 16 can be filled with a concrete mixture 18 (e.g., wetted cement with suspended aggregate). After the concrete mixture 18 has solidified to a sufficient degree, the bottom wall 12 (commonly a steel pallet) can be moved downward relative to the side walls 14. During this process, the concrete mixture 18 (e.g., a partially-solidified concrete block) moves downward with the bottom wall 12 and relative to the side walls 14. To facilitate this downward movement, a force can be applied to the concrete mixture 18 on the surface opposite from the bottom wall 12 (e.g., the top surface 20 of the concrete mixture 18), as is known in the art. Alternatively, the mold side walls 14 can be moved upward while holding the concrete mixture 18 and bottom wall 12 stationary.

FIGS. 2-4 illustrate a side view of three side walls 14 of the block mold 10. The side wall 14 in the center of FIGS. 2-4 includes a textured material 22 on both sides of a bottom portion 24 of the side wall 14. In this configuration, each textured material 22 is exposed to a corresponding mold cavity 16.

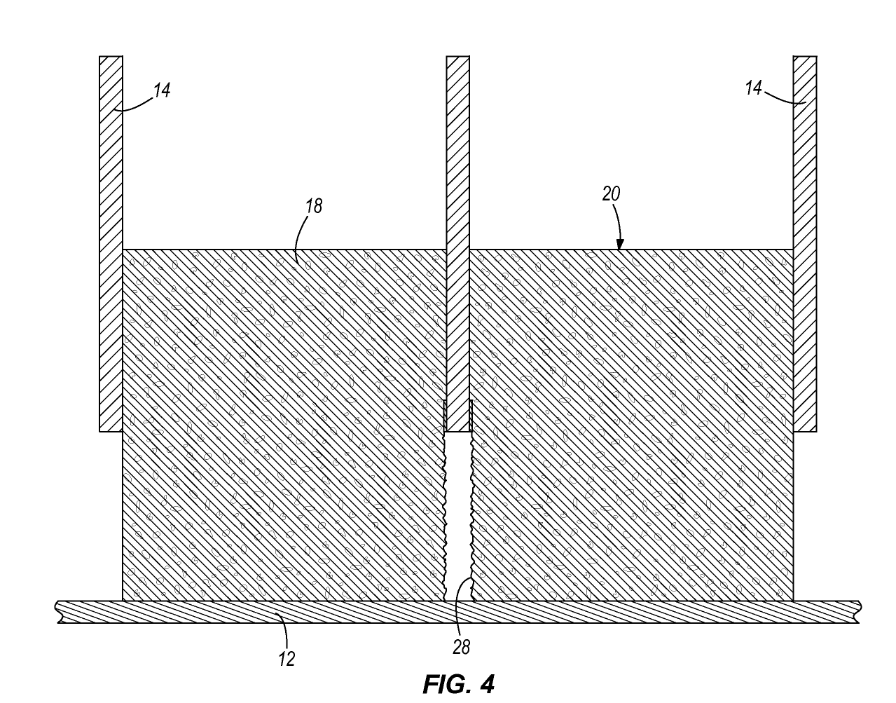

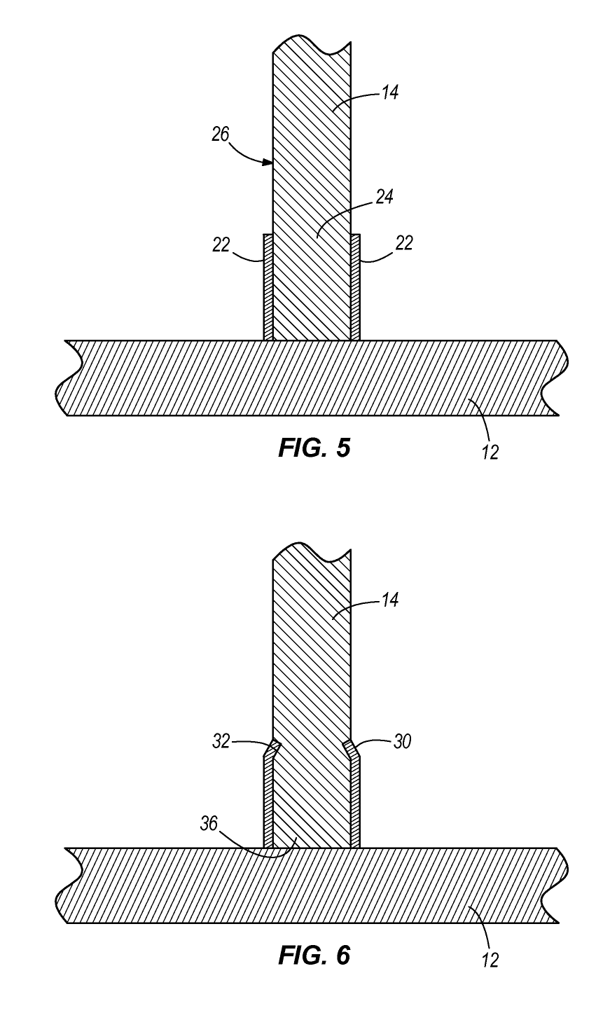

Referring to FIG. 5, the textured material 22 is a composite material comprising diamond grains (about ten to sixty micron mesh size) suspended in a nickel alloy matrix (carbide or other abrasive materials). The textured material 22 is applied to the surface 26 of the side wall 14 using a nickel bond process (e.g., electroplated, electroformed, or vacuum brazed). Such processes are used for coating tools, such as grinding wheels and drill bits. The textured material 22 is applied directly on the side surface 26 of the side wall 14 at a thickness of about 0.015 to 0.020 inches. Referring back to FIG. 4, it can be seen that the textured material 22 will scrape along the surface of the concrete material to create a textured surface 28 on the resulting concrete block 18. It should be understood that other abrasive particles (e.g., carbide) could be used instead of or in addition to the diamond grains. Further, in its broadest application, the matrix of the present invention is not limited to nickel alloy, and can be any material that holds the abrasive particles in place.

Referring to FIG. 6, the textured material 22 can be applied in such a manner as to present a tapered surface 30 as the side wall 14 is moved upward relative to the concrete block 18. More specifically, the side wall 14 is provided with a notch 32 extending along a length of the side wall 14. The textured material 22 is then applied to the side wall 14 such that the upper edge of the textured material 22 is positioned in the notch 32 and extends downward to a lower end 36 of the side wall 14. With this configuration, the textured material 22 includes a tapered surface 30 that provides a more gradual interface between the textured material 22 and the concrete block 18.

Various features and advantages of the invention are set forth in the following claims.

What is claimed is:

1. A block mold for forming a block, comprising:
a bottom wall adapted to form a bottom of the block;
a side wall adapted to form a side of the block, the side wall being movable relative to the bottom wall; and
a textured material on the side wall and adapted to create a textured surface on the block when the side wall is moved relative to the bottom wall, wherein the textured material comprises abrasive particles in a matrix.

2. A block mold as claimed in claim 1, wherein the abrasive particles include diamonds.

3. A block mold as claimed in claim 1, wherein the bottom wall is positioned adjacent a bottom portion of the side wall.

4. A block mold as claimed in claim 2, wherein the textured material is secured to the bottom portion of the side wall.

5. A block mold as claimed in claim 1, wherein the bottom wall and sidewall at least partially define a first mold cavity on a first side of the side wall, wherein the textured material is a first textured material on a first side surface of the side wall, and wherein the bottom wall and sidewall at least partially define a second mold cavity on a second side of the side wall, and wherein the block mold further comprises a second textured material on a second side surface of the side wall.

6. A block mold as claimed in claim 4, wherein the bottom wall is positioned adjacent a bottom portion of the side wall, and wherein the first and second textured materials are secured to the bottom portion of the side wall.

7. A block mold as claimed in claim 1, wherein the side wall includes a side surface defining a plane, and wherein the textured material is applied to the side surface to create the textured surface that protrudes from the plane.

8. A block mold as claimed in claim 1, wherein the textured material is 0.005 to 0.10 inches thick.

9. A block mold as claimed in claim 1, wherein the textured material is 0.01 to 0.03 inches thick.

10. A block mold as claimed in claim 1, wherein the textured material is about 0.02 inches thick.

11. A block mold as claimed in claim 1, wherein the matrix comprises a nickel alloy, and wherein the abrasive particles comprise a diamond grain.

12. A block mold as claimed in claim 11, wherein the diamond grain has a mesh size of ten to sixty microns.

13. A method of forming a block comprising:
providing a block mold having a bottom wall adapted to form a bottom of the block, and a side wall adapted to form a side of the block;
applying a textured material to the side wall, wherein the textured material includes abrasive particles in a matrix;
positioning the bottom wall adjacent to the side wall to form a mold cavity;
filling the cavity with a block material;
moving the bottom wall and block material relative to the side wall; and
scraping the textured material onto a surface of the block material to create a textured surface on the block material.

14. A method as claimed in claim 13, wherein providing comprises positioning the bottom wall adjacent a bottom portion of the side wall.

15. A method as claimed in claim 14, wherein applying a textured material comprises securing the textured material to the bottom portion of the side wall.

16. A method as claimed in claim 13, wherein providing a block mold comprises defining a first mold cavity on a first side of the side wall and defining a second mold cavity on a second side of the side wall, and wherein applying a textured material comprises securing a first textured material on a first side surface of the side wall and securing a second textured material on a second side surface of the side wall.

17. A method as claimed in claim 16, wherein providing a block mold further comprises positioning the bottom wall adjacent a bottom portion of the side wall, and wherein the first and second textured materials are secured to the bottom portion of the side wall.

18. A method as claimed in claim 13, wherein applying a textured material includes coating a portion of the side wall with the textured material comprising the matrix of a nickel alloy and abrasive particles of diamond grain.

19. A method as claimed in claim 18, wherein coating includes bonding the nickel alloy and diamond grain using a nickel bond process.

20. A method as claimed in claim 13, wherein the side wall includes a side surface defining a plane, and wherein applying a textured material comprises positioning the textured material onto the side surface and creating the textured surface that protrudes from the plane.
